(19) United States
(12) Patent Application Publication
(10) Pub. No.: US 2018/0072184 A1
(43) Pub. Date: Mar. 15, 2018

(54) VEHICULAR CHARGING PART LAYOUT STRUCTURE

(71) Applicant: HONDA MOTOR CO., LTD, Tokyo (JP)

(72) Inventors: Christopher Lang, Wako-shi (JP); Kanae Ohkuma, Wako-shi (JP); Yasuhisa Kume, Wako-shi (JP); Kenta Sugitate, Wako-shi (JP)

(21) Appl. No.: 15/698,755

(22) Filed: Sep. 8, 2017

(30) Foreign Application Priority Data
Sep. 13, 2016 (JP) 2016-178427

(51) Int. Cl. B60L 11/18; B60K 1/04; H02J 7/00; H02J 7/02

(52) U.S. Cl. CPC B60L 11/1879; B60L 11/182; B60L 11/1874; B60K 2001/0438; H02J 7/0045; H02J 7/025; B60K 1/04

(57) ABSTRACT

A vehicular charging part layout structure includes a battery case provided at a lower position of a vehicle, a battery accommodated in the battery case, and an electrical power receiving device configured to receive electrical power from the outside of the vehicle, and transmit the electrical power to the battery through a charger. The battery case includes a battery accommodation portion configured to accommodate the battery, and a charger accommodation portion configured to accommodate the charger. The battery accommodation portion and the charger accommodation portion are formed integrally.

### CROSS-REFERENCE TO RELATED APPLICATION

This application is based upon and claims the benefit of priority from Japanese Patent Application No. 2016-178427 filed on Sep. 13, 2016, the contents of which are incorporated herein by reference.

### BACKGROUND OF THE INVENTION

### Field of the Invention

The present invention relates to a vehicular charging part layout structure where a battery case is provided at a lower position of a vehicle.

### Description of the Related Art

Conventionally, as disclosed in Japanese Laid-Open Patent Publication No. 2015-103486, in an electric vehicle including a battery as a power supply of the vehicle, for supplying electrical power consumed in traveling of the vehicle, and a charger connected to the battery, it is known to adopt a structure where the charger is provided in a device case adjacent to a batter case (case different from the battery case).

### SUMMARY OF THE INVENTION

Japanese Laid-Open Patent Publication No. 2015-103486 does not adopt a layout where the battery case is provided at a lower position of the vehicle. Therefore, countermeasures against the contact with the ground and the entry of water when the battery case is provided at a lower position of the vehicle are not taken sufficiently. Further, in Japanese Laid-Open Patent Publication No. 2015-103486, since the battery and the charger are accommodated in individual cases, size reduction in the structure cannot be achieved easily. Further, in Japanese Laid-Open Patent Publication No. 2015-103486, since countermeasures against water and dust need to be taken individually, cost reduction cannot be achieved easily.

The present invention has been made taking the above points into account, and an object of the present invention is to achieve size reduction and cost reduction in a vehicular charging part layout structure where a battery case is provided at a lower position of a vehicle.

In order to achieve the above object, the vehicular charging part layout structure of the present invention includes a battery case provided at a lower position of a vehicle, a battery accommodated in the battery case, and an electrical power receiving device configured to receive electrical power from outside of the vehicle, and transmit electrical power to the battery through a charger. The battery case includes a battery accommodation portion configured to accommodate the battery and a charger accommodation portion configured to accommodate the charger, and the battery accommodation portion and the charger accommodation portion are formed integrally.

In the charging part layout structure having the above structure, the battery case includes the battery accommodation portion and the charger accommodation portion that are formed integrally, and both of the battery and the charger are accommodated in the battery case. Therefore, unlike the structure where the battery and the charger are accommodated individually in cases, it becomes possible to reduce the size of the structure. Further, since it is not necessary to take countermeasures against water and dust for the battery and the charger individually, cost reduction is achieved. Further, since the battery accommodation portion and the charger accommodation portion are formed integrally, these component parts can be attached as a battery case assembly, to the vehicle. Thus, reduction in the number of steps of attaching the component parts to the vehicle is achieved.

Preferably, the charger is provided on one side of the battery in a traveling direction of the vehicle, and the charger accommodation portion is expanded from the battery accommodation portion toward one side in the traveling direction of the vehicle to have a protruded shape in a plan view.

In the structure, it becomes possible to reduce the thickness in the height direction of the battery case. At the time of attaching the battery case to the vehicle body, since it is possible to recognize the front side and the rear side of the battery case easily, it is possible to suitably prevent erroneous assembling.

Preferably, a bottom surface of the charger accommodation portion is positioned above a bottom surface of the battery accommodation portion.

In the structure, when the battery case is damaged due to vehicle body's contact with the ground and water flows into the battery case, the water in the battery case can flow into the battery accommodation portion having the bottom surface at the lower position preferentially. In the structure, it is possible to suppress submersion of the charger.

Preferably, the electrical power receiving device includes a non-contact electrical power receiving unit as a part of a secondary side circuit of a non-contact charging system, a lower surface of the charger accommodation portion is positioned above a lower surface of the battery accommodation portion to form a recess recessed upward, at a lower position of the battery case, and the non-contact electrical power receiving unit is provided in the recess.

In the structure, since the non-contact power receiving unit is provided at a position which would otherwise be a dead space, it is possible to reduce the thickness of the charging part layout structure.

Preferably, the charger is attached to a bracket member configured to sandwich a water jacket made of metal, from upper and lower sides, the battery and the charger are connected together by a DC cable, and a connection terminal of the DC cable for connection with the charger is connected to a charger component part of the charger positioned above the water jacket.

In the structure, when the battery case is damaged, even in the case where the water flows into the battery case, it is possible suppress submersion of the connection terminal of the DC cable for connection with the charger.

Preferably, the battery case is provided at a position surrounded by side frames of the vehicle.

In the structure, when an external load is applied to the vehicle, it is possible to suppress damage of the battery and the charger.

Preferably, a first accommodation chamber is provided in the battery accommodation portion, and a second accommodation chamber is provided in the charger accommodation portion, and the first accommodation chamber and the second accommodation chamber are connected together to form a single space.

In the structure, since no partition wall is present between the battery accommodation portion and the charger accommodation portion, the battery case has a simple structure.

Preferably, the battery and the charger are electrically connected through the DC cable in the battery case.

In the structure, since the DC cable connects the battery and the charger without passing through any partition wall, it is possible to install the DC cable easily.

Preferably, a cooling circuit is provided in the battery case. The cooling circuit includes a battery water jacket made of metal and configured to cool the battery, and a charger water jacket made of metal and configured to cool the charger, and the battery water jacket and the charger water jacket are connected through an intermediate pipe in the battery case.

In the structure, since the intermediate pipe connects the battery water jacket and the charger water jacket without passing through any partition wall, it is possible to install the intermediate pipe easily.

Preferably, the battery water jacket is larger than the charger water jacket in a plan view, and the battery water jacket and the charger water jacket are configured to allow a coolant to flow through the battery water jacket, and then, flow through the charger water jacket.

In the structure, it is possible to cool the battery efficiently.

Preferably, the charger is attached to an upper bracket member and a lower bracket member configured to sandwich a charger water jacket made of metal, from upper and lower sides in the battery case, the charger includes a first charger component part and a second charger component part, the first charger component part is attached to the upper bracket member, and the second charger component part is attached to the lower bracket member.

In the structure, it is possible to cool the charger efficiently.

Preferably, a first through hole is formed in the upper bracket member, and the first charger component part is inserted into the first through hole and contacts an upper surface of the charger water jacket, and a second through hole is formed in the lower bracket member, and the second charger component part is inserted into the second through hole and contacts a lower surface of the charger water jacket.

In the structure, it is possible to cool the charger more efficiently.

In the present invention, it is possible to achieve size reduction and cost reduction of the vehicular charging part layout structure where the battery case is provided at the lower position of the vehicle.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a plan view schematically showing a vehicle having a vehicular charging part layout structure according to an embodiment of the present invention;

FIG. 2 is a side view schematically showing the vehicle;

FIG. 3 is a perspective view showing the vehicular charging part layout structure;

FIG. 4 is a view showing a configuration of a cooling circuit of the vehicular charging part layout structure;

FIG. 5 is an exploded perspective view showing cooling structure of a charger; and

FIG. 6 is a cross sectional view showing main components of the vehicular charging part layout structure.

### DESCRIPTION OF THE PREFERRED EMBODIMENTS

Hereinafter, a preferred embodiment of a vehicular charging part layout structure according to the present invention will be described in detail with reference to the accompanying drawings.

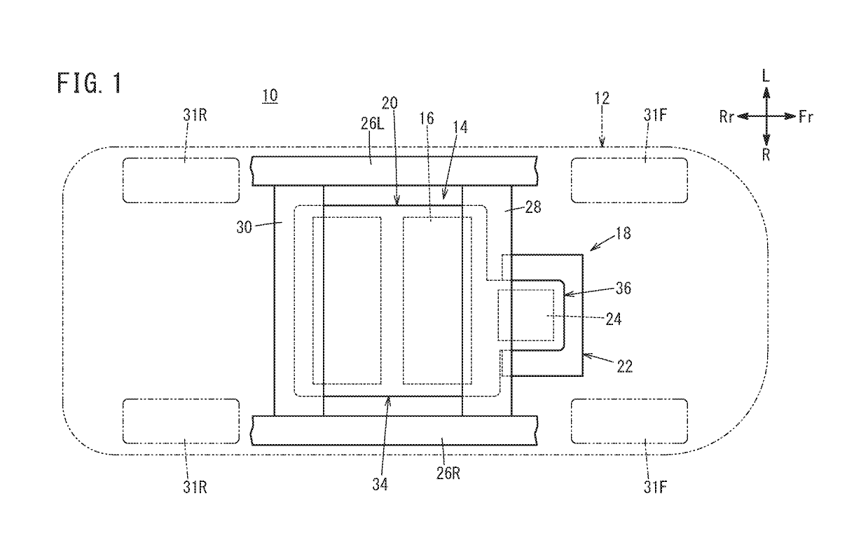

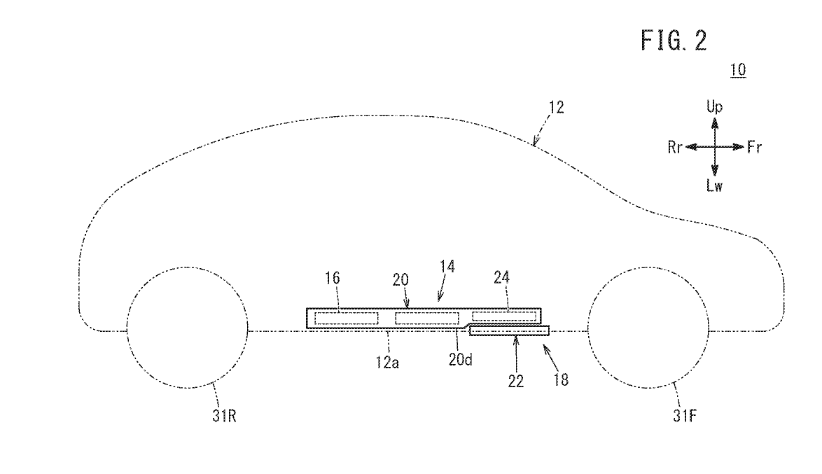

As shown in FIGS. 1 and 2, a vehicular charging part layout structure 14 according to the embodiment of the present invention (hereinafter referred to as the “charging part layout structure 14”) is provided at a lower position of a vehicle body 12 of a vehicle 10. The vehicle 10 may be in the form of an electric vehicle in a narrow sense which travels by only a driving force of a traction motor (not shown) utilizing electrical power supplied from a battery 16 described later.

The vehicle 10 may be in the form of an electric vehicle having another driving source (engine, etc.) in addition to the traction motor. Further, the vehicle 10 may be in the form of an electric vehicle having another power source (fuel cell, etc.) in addition to the battery 16. The vehicle 10 may travel utilizing only another driving source (engine, etc.) without having the traction motor. In this case, the battery 16 may be a low voltage battery such as a 12V battery.

The charging part layout structure 14 includes the battery 16, a power receiving device 18, and a battery case 20. The battery 16 is an energy storage made up of a plurality of battery cells. For example, a lithium ion secondary battery, a nickel hydrogen (nickel-metal hydride) secondary battery, or a capacitor may be used as the battery 16.

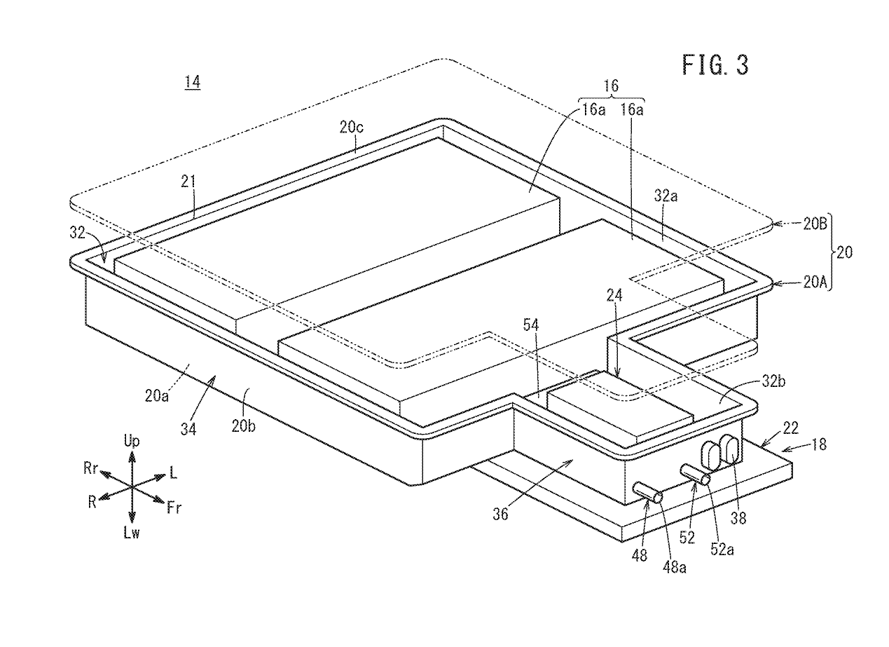

As shown in FIG. 3, in the embodiment of the present invention, the battery 16 includes two battery units 16a. Each of the battery units 16a is made up of the plurality of battery cells. It should be noted that the battery 16 may include only one battery unit 16a. Alternatively, the battery 16 may include two or more battery units 16a. The battery 16 is accommodated in the battery case 20. The structure of the battery case 20 will be described later.

The power receiving device 18 receives electrical power from an external power feeding device (not shown), and sends (supplies) the electrical power to the battery 16. In the embodiment of the present invention, the power receiving device 18 is in the form of a non-contact power receiving device on the secondary side (power receiving side). The non-contact power receiving device on the secondary side and a non-contact power feeding device on the primary side (power feeding side) (not shown) as the external power feeding device jointly make up a non-contact charging system. Therefore, the battery 16 is charged by the outer power feeding device in a non-contact manner.

The power receiving device 18 is a power receiving circuit including a power receiving pad 22 and a charger 24. Though the power receiving device 18 is not shown in detail, a power receiving coil is embedded in the power receiving pad 22. The power receiving coil is an electric circuit which receives alternating current electrical power in a non contact manner, from the power feeding pad having the embedded power receiving coil in the non-contact power feeding device.

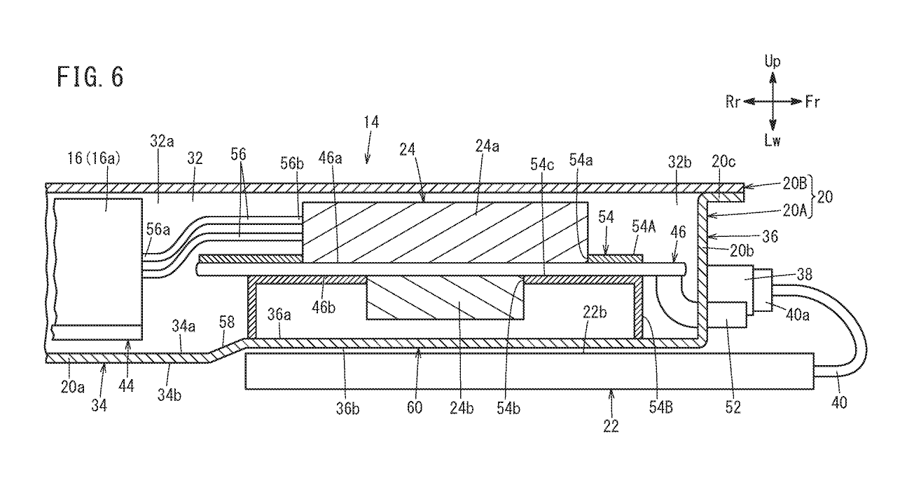

The charger 24 is an electrical circuit which rectifies and converts the alternating current electrical power received by the power receiving pad 22 (power receiving coil) into direct current electrical power, and transmits the direct current electrical power to the battery 16. The power receiving pad 22 and the charger 24 are connected together electrically through an AC cable 40 (see FIG. 6) provided outside the battery case 20.

The power receiving coil embedded in the power receiving pad 22 is a so called solenoid coil (tubular coil). The power receiving coil may be a different type of coil. Using the power receiving and the power feeding coil, it is possible to utilize a magnetic resonance scheme as the non-contact electrical power transmission scheme. It should be noted that other electrical power supply schemes such as an electromagnetic induction scheme may be used as the non-contact electrical power transmission scheme.

As shown in FIG. 2, the battery case 20 is at a lower position of the vehicle 10 (vehicle body 12). The battery case 20 has a plate shape as a whole. In a lower surface 12a of the vehicle body 12, a lower surface 20d of the battery case 20 is exposed. The lower surface 20d of the battery case 20 faces a road surface on which the vehicle 10 travels.

As shown in FIG. 1, the battery case 20 is provided at a position surrounded by left and right side frames 26L, 26R of the vehicle 10. Specifically, the battery case 20 is attached to cross frames 28, 30 extending in a vehicle width direction (indicated by arrows L and R) between the left and right side frames 26L, 26R using suitable fixing parts (tightening parts, etc.). The battery case 20 is positioned between the left and right side frames 26L, 26R. The battery case 20 is positioned below a vehicle compartment of the vehicle 10. Further, in the embodiment of the present invention, the battery case 20 is positioned between front wheels 31F and rear wheels 31R.

As shown in FIG. 3, the battery case 20 includes a lower case 20A in the form of a tray, and an upper case 20B in the form of a plate. The upper case 20B closes an opening 21 of the lower case 20A. The opening 21 of the lower case 20A is closed by the upper case 20B in a liquid tight manner. That is, the upper case 20B is a lid member which closes the lower case 20A in the liquid tight manner. The battery case 20 sealed in the liquid tight manner forms a water proof/dust proof partition wall for protecting the battery 16 and the charger 24 against the external environment.

The lower case 20A includes a bottom wall 20a (see also FIG. 6), a side wall 20b, and a flange 20c. The side wall 20b protrudes upward from a marginal portion of the bottom wall 20a, and extends around the lower case 20A along the marginal portion. The flange 20c protrudes outward in the horizontal direction from the upper end of the side wall 20b, and extends around the lower case 20A along the upper end. A recess as an accommodation chamber 32 is provided inside the lower case 20A in the form of a tray as described above. The accommodation chamber 32 accommodates both of the above battery 16 and charger 24.

Specifically, the lower case 20A includes a battery accommodation portion 34 accommodating the battery 16 and a charger accommodation portion 36 accommodating the charger 24. The battery accommodation portion 34 and the charger accommodation portion 36 are formed integrally. That is, the lower case 20A of the battery case 20 is formed integrally with the charger accommodation portion 36.

The lower case 20A includes a first accommodation chamber 32a as part of the accommodation chamber 32 and a second accommodation chamber 32b as the other part of the accommodation chamber 32. The first accommodation chamber 32a and the second accommodation chamber 32b are connected together to form a continuous space (accommodation chamber 32). A connection terminal 38 is provided at the side wall 20b of the charger accommodation portion 36. A connector 40a of the AC cable 40 extending from the electrical power receiving pad 22 is connected to the connection terminal 38 (see FIG. 6). The volume of the charger accommodation portion 36 (second accommodation chamber 32b) is smaller than the volume of the battery accommodation portion 34 (first accommodation chamber 32a).

In the embodiment of the present invention, the lower case 20A is a one-piece component part formed by combining the battery accommodation portion 34 and the charger accommodation portion 36 seamlessly. It should be noted that the battery accommodation portion 34 and the charger accommodation portion 36 may be members coupled together, e.g., using suitable tightening parts (bolt, etc.) or adhesive, etc. In this case, these members need to be coupled together using a seal member to achieve the desired liquid tightness.

It should be noted the upper case 20B may not be provided. In this case, the lower case 20A is attached to the lower surface 12a of the vehicle body 12 to close the opening 21 of the lower case 20A in a liquid tight manner.

As shown in FIGS. 1 and 3, the charger 24 is provided on one side of the battery 16 in the traveling direction of the vehicle (front side (indicated by an arrow Fr) in the traveling direction of the vehicle in the embodiment). The charger accommodation portion 36 is expanded from the battery accommodation portion 34 in the traveling direction of the vehicle (front side in the traveling direction of the vehicle in the embodiment). The charger accommodation portion 36 has a protruded shape in a plan view.

Conversely to the embodiment of the present invention, the charger 24 may be provided on the back side of the battery 16 in the traveling direction of the vehicle (indicated by an arrow Rr), and the charger accommodation portion 36 may be expanded from the battery accommodation portion 34 backward in the traveling direction of the vehicle, to have a protruded shape in a plan view.

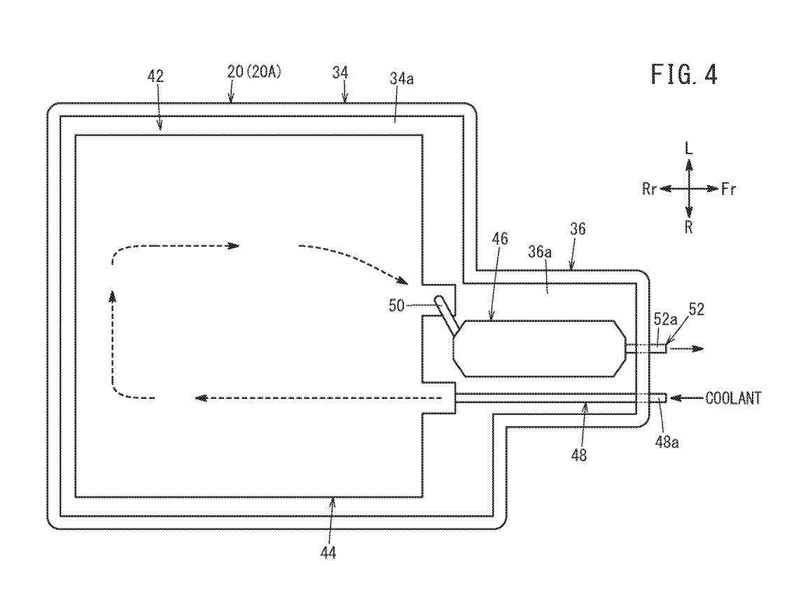

In order to cool the battery 16 and the charger 24, as shown in FIG. 4, a cooling circuit 42 is provided in the battery case 20. In FIG. 4, for ease of understanding of the layout structure of the cooling circuit 42, the upper case 20B is removed (not shown in FIG. 4), and the battery 16 and the charger 24 are not shown.

The cooling circuit 42 includes a battery water jacket 44 made of metal for cooling the battery 16 and a charger water jacket 46 made of metal for cooling the charger 24. The battery water jacket 44 is in the form of a plate (flat shape), and contacts the battery 16 (see FIG. 6). In the embodiment of the present invention, the battery water jacket 44 is provided below the battery 16, and contacts a lower surface of the battery 16 (lower surface of each of the battery units 16a). The charger water jacket 46 is in the form of a plate (flat shape), and contacts the charger 24 (described later in detail).

In FIG. 4, coolant (e.g., water) is supplied from a coolant supply apparatus (not shown) to the battery water jacket 44 through a first pipe 48. Consequently, the battery 16 is cooled. The first pipe 48 passes through the battery case 20 (specifically, the charger accommodation portion 36) in a liquid tight manner. A portion 48a protruding from the battery case 20 serves as a coolant inlet port.

The battery water jacket 44 and the charger water jacket 46 are connected through an intermediate pipe 50. After the coolant flows through the battery water jacket 44, the coolant is supplied to the charger water jacket 46 through the intermediate pipe 50. Consequently, the charger 24 is cooled.

The coolant supplied to the charger water jacket 46 flows through the charger water jacket 46, and then, the coolant is discharged through a second pipe 52. The second pipe 52 passes through the battery case 20 (specifically, the charger accommodation portion 36) in a liquid tight manner. A portion 52a protruding from the battery case 20 serves as a coolant outlet port.

The coolant discharged from the second pipe 52 is returned to a coolant supply apparatus. Then, the coolant is again, supplied to the battery water jacket 44 through the first pipe 48.

It should be noted that the coolant may flow in a direction opposite to the direction described above. That is, the coolant may flow from the second pipe 52, the charger water jacket 46, the intermediate pipe 50, and then, the first pipe 48. In this case, the portion 52a of the second pipe 52 protruding from the battery case 20 serves as the coolant inlet, and the portion 48a of the first pipe 48 protruding from the battery case 20 serves as the coolant outlet.

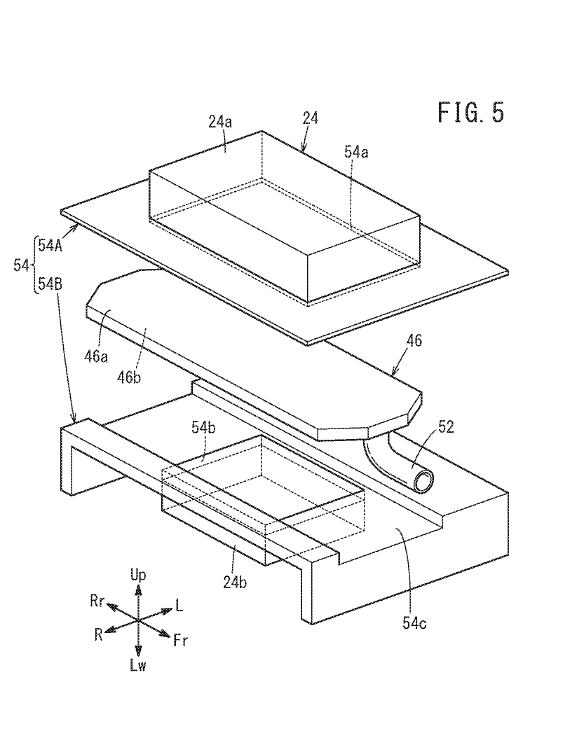

As shown in FIGS. 5 and 6, the charger 24 is attached to a bracket member 54 which sandwiches the charger water jacket 46 made of metal, from upper and lower sides. Specifically, the bracket member 54 includes an upper bracket member 54A and a lower bracket member 54B. The upper bracket member 54A and the lower bracket member 54B are accommodated in the charger accommodation portion 36 together with the charger 24.

Charger component parts 24a, 24b of the charger 24 are attached to the upper bracket member 54A and the lower bracket member 54B, respectively. The charger water jacket 46 is sandwiched, and held between the upper bracket member 54A and the lower bracket member 54B, from upper and lower sides. The upper bracket member 54A and the lower bracket member 54B are fixed together using suitable tightening parts.

A through hole 54a passes through the upper bracket member 54A, and a portion (lower portion) of the charger component part 24a on the upper side is inserted into the through hole 54a. In the structure, the charger component part 24a on the upper side contacts an upper surface 46a of the charger water jacket 46 through the through hole 54a. In the case where the upper bracket member 54A is made of metal, the through hole 54a may not be provided, and the charger component part 24a on the upper side may be cooled by the charger water jacket 46 through the upper bracket member 54A.

The lower bracket member 54B is fixed to a bottom surface 36a of the charger accommodation portion 36 using suitable fixing parts (screws, etc.). A retaining recess 54c is formed in an upper surface of the lower bracket member 54B. The retaining recess 54c is recessed downward. The charger water jacket 46 is provided in the retaining recess 54c. The charger water jacket 46 is fixed to the lower bracket member 54B using suitable fixing parts (screws, etc.). It should be noted that the charger water jacket 46 may be fixed to the upper bracket member 54A.

A through hole 54b passes through the lower bracket member 54B. The through hole 54b is opened to the retaining recess 54c. A portion (upper portion) of the charger component part 24b on the lower side is inserted into the through hole 54b. In the structure, the charger component part 24b on the lower side contacts a lower surface 46b of the charger water jacket 46 through the through hole 54b. It should be noted that, in the case where the lower bracket member 54B is made of metal, the through hole 54b may not be provided, and the charger component part 24b on the lower side may be cooled by the charger water jacket 46 through the lower bracket member 54B.

As shown in FIG. 6, the battery 16 and the charger 24 are electrically connected together by a DC cable 56. One end (one connection terminal 56a) of the DC cable 56 is connected to the battery 16 in the battery accommodation portion 34. Another end (another connection terminal 56b) of the DC cable 56 is connected to the charger 24 (the upper charger component part 24a in the embodiment of the present invention) in the charger accommodation portion 36. Therefore, the connection terminal 56b of the DC cable 56 for connection with the charger 24 is positioned above the charger water jacket 46.

As shown in FIG. 6, the bottom surface 36a of the charger accommodation portion 36 is positioned above a bottom surface 34a of the battery accommodation portion 34 (on the upper side in the vertical direction of the vehicle (on the side indicated by an arrow Up)). The bottom surface 36a of the charger accommodation portion 36 is adjacent to the bottom surface 34a of the battery accommodation portion 34 through an inclined wall 58. The bottom surface 36a of the charger accommodation portion 36 may be adjacent to the bottom surface 34a of the battery accommodation portion 34 through a vertical wall extending in the vertical direction of the vehicle (direction indicated by the arrows Up and Lw).

In the battery case 20 (lower case 20A) according to the embodiment of the present invention, a lower surface 36b of the charger accommodation portion 36 is positioned above a lower surface 34b of the battery accommodation portion 34 to form a recess 60 recessed upward, at a lower position of the battery case 20. The electrical power receiving pad 22 is provided in the recess 60. Specifically, the “electrical power receiving pad 22 is provided in the recess 60” means that the electrical power receiving pad 22 is positioned below the charger accommodation portion 36 such that an upper surface 22b of the electrical power receiving pad 22 is positioned above the lower surface 34b of the battery accommodation portion 34.

It should be noted that the electrical power receiving pad 22 may be directly attached to the battery case 20 (battery accommodation portion 34), and may be attached to the frame (the above described cross frame 28, etc.) of the vehicle 10. The upper surface 22b of the electrical power receiving pad 22 may contact the lower surface 36b of the charger accommodation portion 36, and may face the lower surface 36b of the charger accommodation portion 36 at a distance.

Next, operation of the charging part layout structure 14 having the above structure will be described.

In the charging part layout structure 14 according to the embodiment of the present invention, the battery case 20 includes the battery accommodation portion 34 and the charger accommodation portion 36 that are formed integrally, and both of the battery 16 and the charger 24 are accommodated in the battery case 20. Therefore, unlike the structure where the battery 16 and the charger 24 are accommodated individually in a case, it becomes possible to reduce the size of the structure. Further, since it is not necessary to take countermeasures against water and dust for the battery 16 and the charger 24 individually, cost reduction is achieved. Further, since the battery accommodation portion 34 and the charger accommodation portion 36 are formed integrally, these component parts can be attached to the vehicle 10 as a battery case assembly. Thus, reduction in the number of steps for attaching the component parts to the vehicle 10 is achieved.

In the embodiment of the present invention, the charger 24 is provided on one side of the battery 16 in the traveling direction of the vehicle, and the charger accommodation portion 36 is expanded from the battery accommodation portion 34 on one side in the traveling direction of the vehicle to have a protruded shape in a plan view. In the structure, it becomes possible to reduce the thickness in the height direction of the battery case 20. Further, at the time of attaching the battery case 20 to the vehicle body 12, since it is possible to recognize the front side and the rear side of the battery case 20 easily, it is possible to suitably prevent erroneous assembling.

In the embodiment of the present invention, the bottom surface 36a of the charger accommodation portion 36 is positioned above the bottom surface 34a of the battery accommodation portion 34 (see FIG. 6). In the structure, when the vehicle body 12 is brought into contact with the ground and the battery case 20 is damaged to cause water to flow therein, the water in the battery case 20 can flow into the battery accommodation portion 34 having the bottom surface 34a at the lower position preferentially. In the structure, it is possible to suppress submersion of the charger 24.

In the embodiment of the present invention, the electrical power receiving device 18 includes an electrical power receiving pad 22 (non-contact power receiving unit) of the secondary side circuit of the non-contact charging system. Further, the lower surface 36b of the charging accommodation portion 36 is positioned above the lower surface 34b of the battery accommodation portion 34. The recess 60 recessed upward is formed at a lower position of the battery case 20. The electrical power receiving pad 22 is provided in the recess 60. In the structure, since the power receiving pad 22 is provided at a position which would otherwise be a dead space, it is possible to reduce the thickness of the charging part layout structure 14. In the embodiment of the present invention, the charger 24 is attached to the bracket member 54 sandwiching the charger water jacket 46, from upper and lower sides. The battery 16 and the charger 24 are connected by the DC cable 56. Further, the connection terminal 56b of the DC cable 56 for connection with the charger 24 is connected to the charger component part 24a positioned above the charger water jacket 46. Therefore, even in the case where the battery case 20 is damaged and water flows into the battery case 20, it is possible to suppress submersion of the connection terminal 56b of the DC cable 56 for connection with the charger 24.

In the embodiment of the present invention, the battery case 20 is provided at the position surrounded by the side frames 26L, 26R of the vehicle 10 (see FIG. 1). Therefore, in the event that an external load is applied to the vehicle 10, it is possible to suppress damage of the battery 16 and the charger 24.

The first accommodation chamber 32a is provided in the battery accommodation portion 34, the second accommodation chamber 32b is provided in the charger accommodation portion 36, and the first accommodation chamber 32a and the second accommodation chamber 32b are connected together to form a single space. In the structure, since no partition wall is present between the battery accommodation portion 34 and the charger accommodation portion 36, the battery case 20 has a simple structure.

The battery 16 and the charger 24 are connected together electrically through the DC cable 56 in the battery case 20. Therefore, since the DC cable 56 connects the battery 16 and the charger 24 without passing through any partition wall, it is possible to install the DC cable 56 easily.

The cooling circuit 42 is provided inside the battery case 20. The cooling circuit 42 includes the battery water jacket 44 made of metal for cooing the battery 16 and the charger water jacket 46 made of metal for cooling the charger 24. Further, the battery water jacket 44 and the charger water jacket 46 are connected together in the battery case 20 through the intermediate pipe 50.

Therefore, since the intermediate pipe 50 connects the battery water jacket 44 and the charger water jacket 46 without passing through any partition wall, it is possible to install the intermediate pipe 50 easily.

The battery water jacket 44 is larger than the charger water jacket 46 in a plan view. The coolant flows through the battery water jacket 44, and then, flows through the charger water jacket 46. In the structure, it is possible to cool the battery 16 efficiently.

The charger 24 is attached to the upper bracket member 54A and the lower bracket member 54B which sandwich the charger water jacket 46 made of metal, from upper and lower sides, in the battery case 20. The charger 24 includes the charger component part 24a (first charger component part) and the charger component part 24b (second charger component part). The charger component part 24a is attached to the upper bracket member 54A. The charger component part 24b is attached to the lower bracket member 54B. In the structure, it is possible to cool the charger 24 efficiently.

The through hole 54a (first through hole) is formed in the upper bracket member 54A, the charger component part 24a is inserted into the through hole 54a, and contacts the upper surface 46a of the charger water jacket 46. The through hole 54b (second through hole) is formed in the lower bracket member 54B, the charger component part 24b is inserted into the through hole 54b, and contacts the lower surface 46b of the charger water jacket 46. In the structure, it is possible to cool the charger 24 more efficiently.

Although the embodiment of the present invention has been described in connection with the non-contact charging system, the present invention is applicable to the contact charging system as well. In this case, the above described electrical power receiving device 18 is provided as a secondary side circuit in the contact charging system.

The present invention is not limited to the above described embodiment. It is a matter of course that various modifications can be made without departing from the gist of the present invention.

What is claimed is:

1. A vehicular charging part layout structure comprising:
a battery case provided at a lower position of a vehicle;
a battery accommodated in the battery case; and
an electrical power receiving device configured to receive electrical power from outside of the vehicle, and transmit electrical power to the battery through a charger,
wherein the battery case includes a battery accommodation portion configured to accommodate the battery, and a charger accommodation portion configured to accommodate the charger, and
wherein the battery accommodation portion and the charger accommodation portion are formed integrally.

2. The vehicular charging part layout structure according to claim 1, wherein the charger is provided on one side of the battery in a traveling direction of the vehicle; and
the charger accommodation portion is expanded from the battery accommodation portion toward one side in the traveling direction of the vehicle to have a protruded shape in a plan view.

3. The vehicular charging part layout structure according to claim 2, wherein a bottom surface of the charger accommodation portion is positioned above a bottom surface of the battery accommodation portion.

4. The vehicular charging part layout structure according to claim 3,
wherein the electrical power receiving device includes a non-contact electrical power receiving unit as a part of a secondary side circuit of a non-contact charging system;
a lower surface of the charger accommodation portion is positioned above a lower surface of the battery accommodation portion to form a recess recessed upward, at a lower position of the battery case; and
the non-contact electrical power receiving unit is provided in the recess.

5. The vehicular charging part layout structure according to claim 4, wherein the charger is attached to a bracket member configured to sandwich a water jacket made of metal, from upper and lower sides;
the battery and the charger are connected together by a DC cable; and
a connection terminal of the DC cable for connection with the charger is connected to a charger component part of the charger positioned above the water jacket.

6. The vehicular charging part layout structure according to claim 1, wherein the battery case is provided at a position surrounded by side frames of the vehicle.

7. The vehicular charging part layout structure according to claim 1, wherein a first accommodation chamber is provided in the battery accommodation portion, and a second accommodation chamber is provided in the charger accommodation portion; and
the first accommodation chamber and the second accommodation chamber are connected together to form a single space.

8. The vehicular charging part layout structure according to claim 7,
wherein the battery and the charger are electrically connected through the DC cable in the battery case.

9. The vehicular charging part layout structure according to claim 7,
wherein a cooling circuit is provided in the battery case;
the cooling circuit includes a battery water jacket made of metal and configured to cool the battery, and a charger water jacket made of metal and configured to cool the charger; and
the battery water jacket and the charger water jacket are connected through an intermediate pipe in the battery case.

10. The vehicular charging part layout structure according to claim 9,
wherein the battery water jacket is larger than the charger water jacket in a plan view; and
the battery water jacket and the charger water jacket are configured to allow a coolant to flow through the battery water jacket, and then, flow through the charger water jacket.

11. The vehicular charging part layout structure according to claim 1,
wherein the charger is attached to an upper bracket member and a lower bracket member configured to sandwich a charger water jacket made of metal, from upper and lower sides in the battery case;
the charger includes a first charger component part and a second charger component part;
the first charger component part is attached to the upper bracket member; and
the second charger component part is attached to the lower bracket member.

12. The vehicular charging part layout structure according to claim 11,
wherein a first through hole is formed in the upper bracket member, and the first charger component part is inserted into the first through hole and contacts an upper surface of the charger water jacket; and
a second through hole is formed in the lower bracket member, and the second charger component part is inserted into the second through hole and contacts a lower surface of the charger water jacket.
